(19) United States
(12) Patent Application Publication
(10) Pub. No.: US 2018/0176637 A1
(43) Pub. Date: Jun. 21, 2018

(54) APPARATUS AND METHOD FOR RETRANSMITTING ADVANCED TELEVISION SYSTEMS COMMITTEE (ATSC) 3.0 DIGITAL TV BROADCAST

(71) Applicant: Electronics and Telecommunications Research Institute, Daejeon (KR)

(72) Inventors: Yong Seong CHO, Daejeon (KR); Byungjun BAE, Daejeon (KR); Hye Ju OH, Daejeon (KR); Joon Young JUNG, Daejeon (KR); Namho HUR, Sejong-si (KR)

(73) Assignee: Electronics and Telecommunications Research Institute, Daejeon (KR)

(21) Appl. No.: 15/827,305

(22) Filed: Nov. 30, 2017

(30) Foreign Application Priority Data
Dec. 16, 2016 (KR) 10-2016-0172385
Nov. 15, 2017 (KR) 10-2017-0152554

(51) Int. Cl. H04N 21/438; H04N 21/4402; H04N 21/647; H04N 21/61

(52) U.S. Cl. CPC H04N 21/4382; H04N 21/440218; H04N 21/6143; H04N 21/6112; H04N 21/6125; H04N 21/64707

(57) ABSTRACT

Provided are an apparatus for retransmitting an advanced television systems committee (ATSC) 3.0 digital TV broadcast and methods of the same, the apparatus including a receiver configured to selectively receive at least one of an ATSC 3.0 based digital broadcast signal and an ATSC 3.0 based Internet Protocol (IP) packet input through a first network, a controller configured to generate a moving picture experts group-2 transport stream (MPEG-2 TS) packet by converting audio/video (A/V) packets and signaling information to be received at a second network based on an output signal of the receiver, and extract and provide broadcast program information for a system information (SI) system of a digital broadcast headend to generate an SI table related to a broadcast program converted to MPEG-2 TS, and a transmitter configured to transmit broadcast data to which the MPEG-2 TS packet is converted and the broadcast program information through the second network.

### CROSS-REFERENCE TO RELATED APPLICATION(S)

This application claims the priority benefit of Korean Patent Application No. 10-2016-0172385 filed on Dec. 16, 2016 and Korean Patent Application No. 10-2017-0152554 filed on Nov. 15, 2017, in the Korean Intellectual Property Office, the disclosures of which are incorporated herein by reference for all purposes.

### BACKGROUND

### 1. Field

One or more example embodiments relate to an apparatus and method for retransmitting an advanced television systems committee (ATSC) 3.0 digital TV broadcast.

### 2. Description of Related Art

Existing digital TV broadcast systems such as a terrestrial broadcast system, a cable broadcast system, and a satellite broadcast system transmit video, audio, and additional data in a moving picture experts group-2 transport stream (MPEG-2 TS) transmission format to transmit digital broadcasts in real time.

Recently, a consumption of broadcast content using potable smart terminals capable of Internet Protocol (IP) connection is increasing rapidly all over the world. Further, broadcasters and electronics companies have increasing interest in huge ultra high definition (UHD) broadcasting services.

The ATSC 3.0 broadcast standard established mainly for North American countries introduced an IP based broadcast content transmission scheme to increase a transmission capacity by changing a transmission scheme of a physical layer to transmit huge UHD broadcast content through terrestrial broadcast networks, and to provide a more efficient, highly compatible broadcasting service using all broadcast networks and broadband networks to accept a change in consumption pattern of broadcast content.

A digital broadcast retransmission system is equipment used to relay a broadcast between heterogeneous networks. For example, the digital broadcast retransmission system is used to transmit a digital terrestrial or satellite broadcast received through an antenna of a communal housing block to each household through an integrated reception system, or to retransmit a digital terrestrial broadcast received from a cable broadcasting station over a digital cable transmission network.

However, a recently standardized ATSC 3.0 standard based digital broadcast has a modulation scheme, an audio/video (A/V) compression and transmission scheme, and a broadcast signaling scheme differing from those of the existing digital broadcast, and thus the existing digital broadcast retransmission system may not be used.

### SUMMARY

An aspect provides a technology that may retransmit an advanced television systems committee (ATSC) 3.0 digital TV broadcast by converting the ATSC 3.0 based digital broadcast to an existing moving picture experts group-2 transport stream (MPEG-2 TS) based broadcast.

Another aspect also provides a technology that may allow a user to view a new type of digital broadcast using an existing internet protocol (IP) TV, an existing cable, and an existing satellite broadcasting receiver.

According to an aspect, there is provided a retransmission apparatus including a receiver configured to selectively receive at least one of an ATSC 3.0 based digital broadcast signal and an ATSC 3.0 based IP packet input through a first network, a controller configured to generate a moving picture experts group-2 transport stream (MPEG-2 TS) packet by converting audio/video (A/V) packets and signaling information to be received at a second network based on an output signal of the receiver, and extract and provide broadcast program information for a system information (SI) system of a digital broadcast headend to generate an SI table related to a broadcast program converted to MPEG-2 TS, and a transmitter configured to transmit broadcast data to which the MPEG-2 TS packet is converted and the broadcast program information through the second network.

The ATSC 3.0 based digital broadcast signal may be an ATSC 3.0 based radio frequency (RF) signal.

The broadcast data may be at least one of a second network based digital broadcast signal to which the MPEG-2 TS packet is modulated and a second network based IP packet to which the MPEG-2 TS packet is converted.

The receiver may include an IP input interface configured to receive the ATSC 3.0 based IP packet, and a demodulator configured to demodulate the ATSC 3.0 based RF signal, and extract the ATSC 3.0 based IP packet.

The controller may include an ATSC 3.0 A/V demultiplexer configured to extract the A/V packets by analyzing the ATSC 3.0 based IP packet, a signaling analyzer configured to analyze the ATSC 3.0 based signaling information, generate an MPEG-2 TS based program and system information protocol (PSIP) table from the ATSC 3.0 based signaling information, and extract and provide the broadcast program information, a codec converter configured to convert compression schemes of the A/V packets to compression schemes of MPEG-2 based A/V packets, and an MPEG-2 TS re-multiplexer configured to convert and multiplex the MPEG-2 based A/V packets and the MPEG-2 TS based PSIP table to the MPEG-2 TS packet. The transmitter may include a modulator configured to convert the MPEG-2 TS packet to an MPEG-2 TS based RF signal, and an IP output interface configured to convert the MPEG-2 TS packet to an MPEG-2 TS based IP packet, transmit the MPEG-2 TS based IP packet, and transmit the broadcast program information to the SI system.

The ATSC 3.0 A/V demultiplexer may be configured to extract the A/V packets by analyzing a low level signaling (LLS), a service list table (SLT), and a service level signaling (SLS) from the ATSC 3.0 based IP packet.

The ATSC 3.0 A/V demultiplexer may be configured to extract the A/V packets by analyzing a user service bundle description (USBD), a service-based transport session instance description (S-TSID), and a media processing descriptor (MPD) when the A/V packets are transmitted using real-time object delivery over unidirectional transport (ROUTE), and extract the A/V packets by analyzing the USBD and an MPEG multimedia transport (MMT) package table (MP table) when the A/V packets are transmitted using MPEG media transport protocol (MMTP).

The ATSC 3.0 based IP packet may include the USBD, the S-TSID, the MPD, and the MP table.

The SLT may include information related to a service identification (ID), a service name, a protocol type, a product liability prevention (PLP) number, an IP address, a port number, a major channel number, a minor channel number, and a short service name.

The PSIP table may include a master guide table (MGT), a virtual channel table (VCT), a rating region table (RRT), a system time table (STT), an event information table (EIT), and an event text table (ETT).

The codec converter may be configured to convert the compression scheme of the video packet to at least one of MPEG-2, advanced video coding (AVC), and high efficiency video codec (HEVC) which are compression schemes of the MPEG-2 TS based video packet, and convert the compression scheme of the audio packet to at least one of MPEG-2 and audio codec 3 (AC3) which are compression schemes of the MPEG-2 TS based audio packet.

According to another aspect, there is also provided a retransmission method including selectively receiving at least one of an ATSC 3.0 based digital broadcast signal and an ATSC 3.0 based IP packet input through a first network, generating a MPEG-2 TS packet by converting A/V packets and signaling information to be received at a second network based on at least one of the IP packet and the ATSC 3.0 based digital broadcast signal, and extracting and providing broadcast program information for an SI system of a digital broadcast headend to generate an SI table related to a broadcast program converted to MPEG-2 TS, and transmitting broadcast data to which the MPEG-2 TS packet is converted and the broadcast program information through the second network.

The ATSC 3.0 based digital broadcast signal may be an ATSC 3.0 based RF signal.

The broadcast data may be at least one of a second network based digital broadcast signal to which the MPEG-2 TS packet is modulated and a second network based IP packet to which the MPEG-2 TS packet is converted.

The receiving may include receiving the ATSC 3.0 based IP packet, and demodulating the ATSC 3.0 based RF signal, and extracting the ATSC 3.0 based IP packet.

The generating may include extracting the A/V packets by analyzing the ATSC 3.0 based IP packet, analyzing the ATSC 3.0 based signaling information, generating an MPEG-2 TS based PSIP table from the ATSC 3.0 based signaling information, and extracting and providing the broadcast program information, converting compression schemes of the A/V packets to compression schemes of MPEG-2 based A/V packets, and converting and multiplexing the MPEG-2 based A/V packets and the MPEG-2 TS based PSIP table to the MPEG-2 TS packet.

The transmitting may include converting the MPEG-2 TS packet to an MPEG-2 TS based RF signal, and converting the MPEG-2 TS packet to an MPEG-2 TS based IP packet, transmitting the MPEG-2 TS based IP packet, and transmitting the broadcast program information to the SI system.

The extracting of the A/V packets may include extracting the A/V packets by analyzing an LLS, an SLT, and an SLS from the ATSC 3.0 based IP packet.

The extracting of the A/V packets may include extracting the A/V packets by analyzing a USBD, an S-TSID, and an MPD when the A/V packets are transmitted using ROUTE, and extracting the A/V packets by analyzing the USBD and an MP table when the A/V packets are transmitted using MMTP.

The ATSC 3.0 based IP packet may include the USBD, the S-TSID, the MPD, and the MP table.

The SLT may include information related to a service ID, a service name, a protocol type, a PLP number, an IP address, a port number, a major channel number, a minor channel number, and a short service name.

The PSIP table may include an MGT, a VCT, an RRT, an STT, an EIT, and an ETT.

The converting of the compression schemes of the A/V packets may include converting the compression scheme of the video packet to at least one of MPEG-2, AVC, and HEVC which are compression schemes of the MPEG-2 TS based video packet, and converting the compression scheme of the audio packet to at least one of MPEG-2 and AC3 which are compression schemes of the MPEG-2 TS based audio packet.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a retransmission system according to an example embodiment;

FIG. 2 illustrates an example of a broadcast standard protocol stack of a first network of FIG. 1;

FIG. 3 is a block diagram illustrating the retransmission apparatus of FIG. 1;

FIG. 4 is a flowchart illustrating an example of extracting audio/video (A/V) packets through an advanced television systems committee (ATSC) 3.0 A/V demultiplexer of FIG. 3; and

FIG. 5 is a flowchart illustrating an example of generating a program and system information protocol (PSIP) table through an ATSC 3.0 signaling analyzer of FIG. 3.

### DETAILED DESCRIPTION

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Though the present invention may be variously modified and have several embodiments, specific embodiments will be shown in drawings and be explained in detail. However, the present disclosure is not meant to be limited, but it is intended that various modifications, equivalents, and alternatives are also covered within the scope of the claims.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

In case it is mentioned that a certain component is “connected” or “accessed” to another component, it may be understood that the certain component is directly connected or accessed to the another component or that a component is interposed between the components. On the contrary, in case it is mentioned that a certain component is “directly connected” or “directly accessed” to another component, it should be understood that there is no component therebetween. Other words used to describe the relationship between components should be interpreted in a like fashion (e.g., “between” versus “directly between” or “adjacent” versus “directly adjacent”).

Terms used in the present invention is to merely explain specific embodiments, thus it is not meant to be limiting. A singular expression includes a plural expression except that two expressions are contextually different from each other. In the present invention, a term “include” or “have” is intended to indicate that characteristics, figures, steps, operations, components, elements disclosed on the specification or combinations thereof exist. Rather, the term “include” or “have” should be understood so as not to pre-exclude existence of one or more other characteristics, figures, steps, operations, components, elements or combinations thereof or additional possibility.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, reference will now be made in detail to the example embodiments, examples of which are illustrated in the accompanying drawings, wherein like reference numerals refer to the like elements throughout.

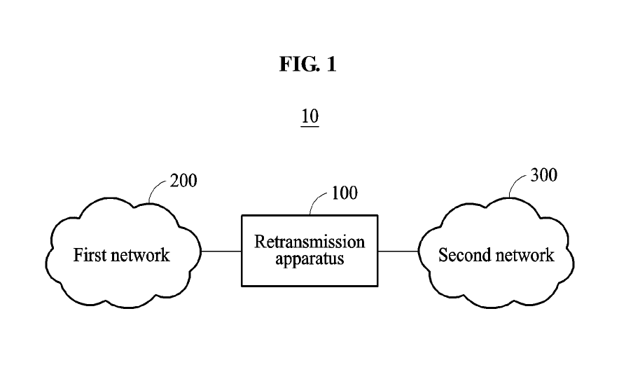

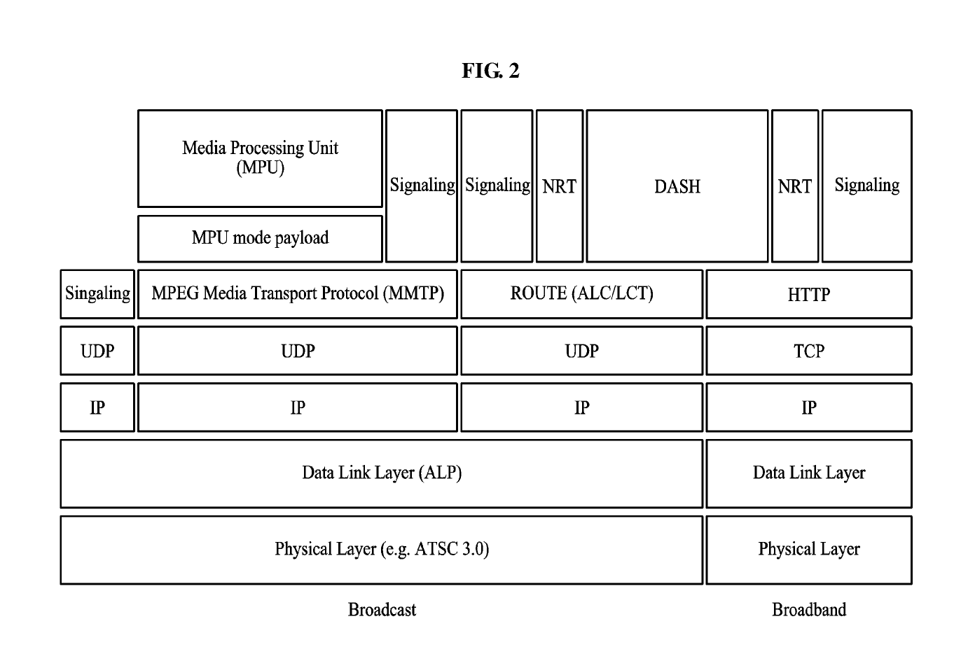

FIG. 1 is a block diagram illustrating a retransmission system according to an example embodiment. FIG. 2 illustrates an example of a broadcast standard protocol stack of a first network of FIG. 1.

Referring to FIGS. 1 and 2, a retransmission system 10 may include a retransmission apparatus 100, a first network 200, and a second network 300.

The retransmission apparatus 100 may selectively receive at least one of a first network based digital broadcast signal and a first network based Internet Protocol (IP) packet transmitted from the first network 200.

The retransmission apparatus 100 may generate a second network based digital broadcast signal and a second network based IP packet suitable for the second network 300 based on the selectively received at least one of the first network based digital broadcast signal and the first network based IP packet, and transmit the second network based digital broadcast signal and the second network based IP packet to the second network 300.

For example, the first network based digital broadcast signal and the first network based IP packet may be an advanced television systems committee (ATSC) 3.0 based digital broadcast signal and an ATSC 3.0 based IP packet. As shown in FIG. 2, the first network 200 may follow an ATSC 3.0 broadcast standard protocol stack, and the first network based digital broadcast signal and the first network based IP packet may be transmitted to the retransmission apparatus 100 according to the ATSC 3.0 broadcast standard protocol stack. In this example, the second network based digital broadcast signal and the second network based IP packet may be an moving picture experts group-2 transport stream (MPEG-2 TS) based digital broadcast signal and an MPEG-2 TS based IP packet suitable for MPEG-2 TS.

A transmitter (not shown) configured to generate and transmit the ATSC 3.0 based digital broadcast signal and the ATSC 3.0 based IP packet may be connected to the first network 200, and a target device, for example, a digital broadcast receiver (not shown), configured to receive the MPEG-2 TS based digital broadcast signal and the MPEG-2 TS based IP packet may be connected to the second network 300. That is, the retransmission apparatus 100 may convert and retransmit signals such that an ATSC 3.0 based digital broadcast may be viewed using an existing target device using an MPEG-2 TS scheme.

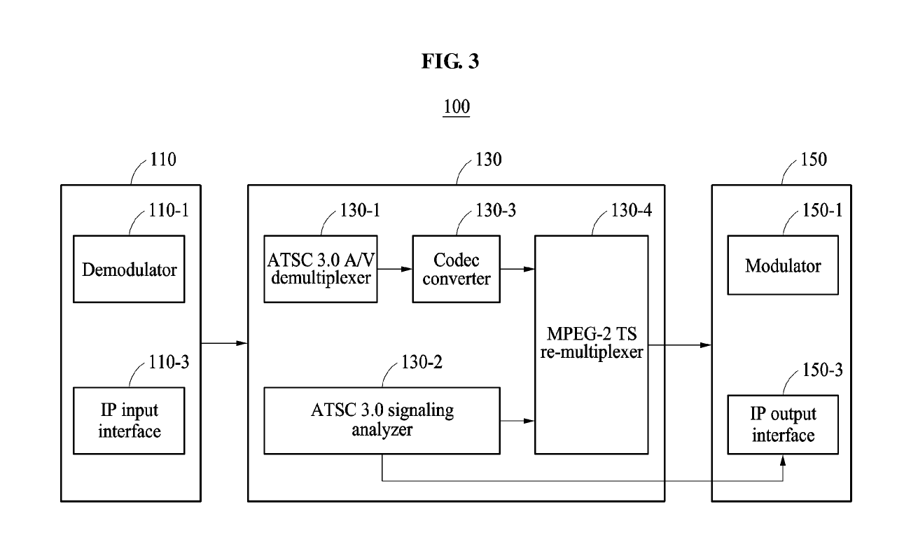

Hereinafter, a configuration and an operation of the retransmission apparatus 100 will be described with reference to FIGS. 3 through 5.

FIG. 3 is a block diagram illustrating the retransmission apparatus of FIG. 1.

Referring to FIG. 3, the retransmission apparatus 100 may include a receiver 110, a controller 130, and a transmitter 150.

The receiver 110 may selectively receive at least one of a first network based digital broadcast signal and a first network based IP packet.

The receiver 110 may include a demodulator 110-1, and an IP input interface 110-3. The receiver 110 may receive a signal through at least one of the demodulator 110-1 and the IP input interface 110-3 based on a control of the controller 130.

The demodulator 110-1 may receive the first network based digital broadcast signal. The first network based digital broadcast signal may be an ATSC 3.0 based digital broadcast signal, for example, an ATSC 3.0 based radio frequency (RF) signal.

Further, the demodulator 110-1 may demodulate the received digital broadcast signal, and extract an IP packet including real-time object delivery over unidirectional transport (ROUTE) or MPEG media transport protocol (MMTP) from the demodulated digital broadcast signal. The demodulator 110-1 may output the extracted IP packet to the controller 130.

The IP input interface 110-3 may receive the first network IP packet, and output the IP packet to the controller 130. In this example, the first network IP packet may be an ATSC 3.0 based IP packet, for example, an IP packet including ROUTE or MMTP.

The IP packet extracted by the demodulator 110-1 and the IP packet received from the IP input interface 110-3 may be IP packets of the same structure.

The controller 130 may control an overall operation of the retransmission apparatus 100. The controller 130 may control operations of the receiver 110 and the transmitter 150. Further, the controller 130 may generate a second network based digital broadcast signal and a second network based IP packet suitable for the second network 300 based on an output signal of the receiver 110, for example, the IP packet extracted by the demodulator 110-1 or the IP packet received from the IP input interface 110-3.

In this example, the IP packet may include a low level signaling (LLS) packet including basic information for channel and service acquisition, and a service layer signaling (SLS) packet including service configuration information. Further, the IP packet may further include a user service bundle description (USBD), a service-based transport session instance description (S-TSID), a media processing descriptor (MPD), and an MPEG media transport (MMT) packet table (MP table).

For example, the LLS packet may include at least one of a service list table (SLT), a rating region table (RRT), and a system time.

In this example, the SLT may include information related to a service identification (ID), a service name, a protocol type, a product liability prevention (PLP) number, an IP address, a port number, a major channel number, a minor channel number, and a short service name.

Further, the RRT may include information related to a rating standard applicable to each region and country, and the system time may include international atomic time (TAI) information.

The controller 130 may include an ATSC 3.0 audio/video (A/V) demultiplexer 130-1, an ATSC 3.0 signaling analyzer 130-2, a codec converter 130-3, and an MPEG-2 TS re-multiplexer 130-4.

The ATSC 3.0 A/V demultiplexer 130-1 may extract A/V packets by analyzing the IP packet.

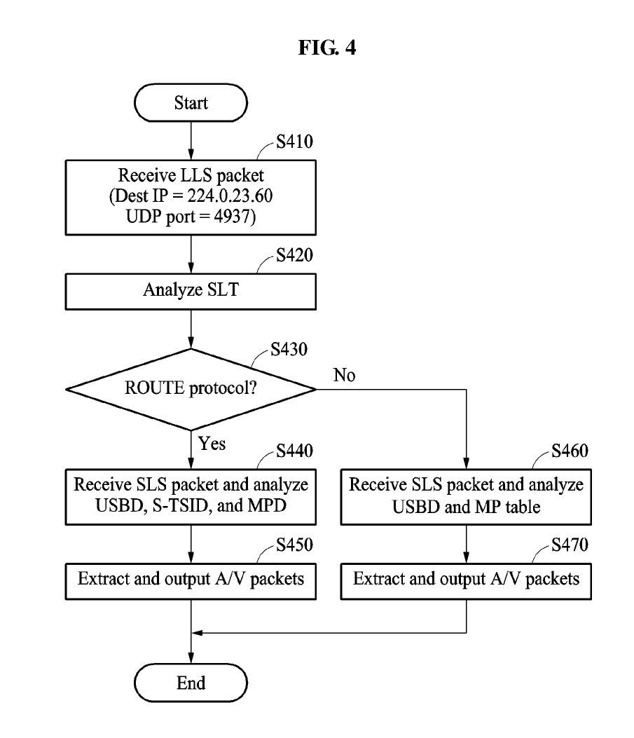

In an example, the ATSC 3.0 A/V demultiplexer 130-1 may extract the A/V packets by analyzing the LLS packet, the SLT packet, and the SLS packet. The example of extracting the A/V packets in the ATSC 3.0 A/V demultiplexer 130-1 will be described further with reference to FIG. 4.

The ATSC 3.0 A/V demultiplexer 130-1 may output the extracted A/V packets to the codec converter 130-3.

The ATSC 3.0 signaling analyzer 130-2 may analyze broadcast signaling information included in the input IP packet. For example, the ATSC 3.0 signaling analyzer 130-2 may obtain SLT information, RRT information, and system time information by extracting an analyzing the LLS packet, and extract and analyze SLS information and electronic service guide (ESG) information based on the SLT information.

The ATSC 3.0 signaling analyzer 130-2 may convert the signaling information. For example, the ATSC 3.0 signaling analyzer 130-2 may convert the ATSC 3.0 based signaling information to a program and system information protocol (PSIP) table used for an existing digital broadcast.

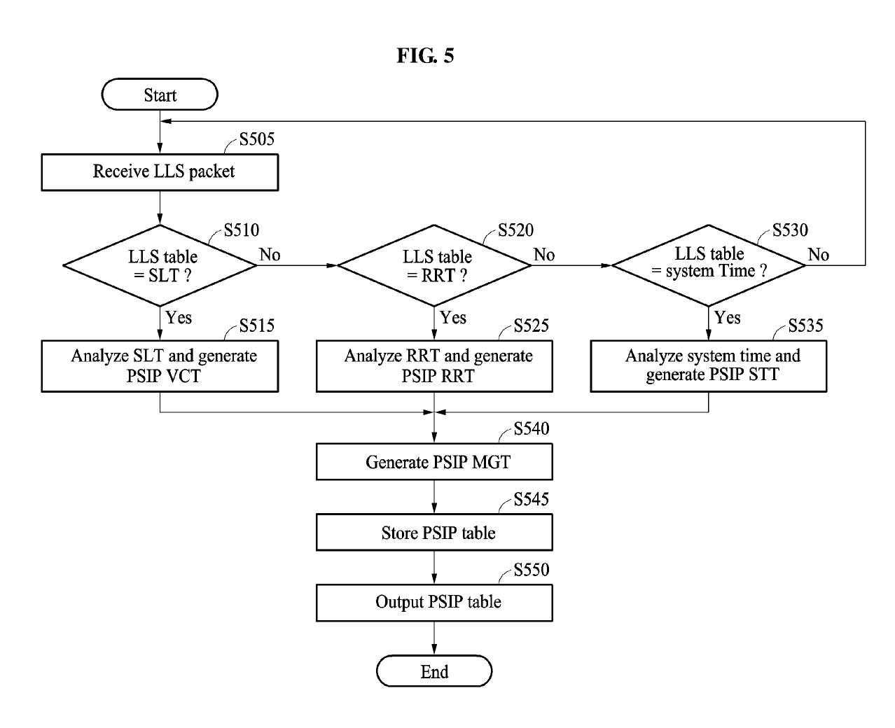

In detail, the ATSC 3.0 signaling analyzer 130-2 may generate the PSIP table by analyzing the LLS, the SLT, the RRT, the system time, and the SLS packet. The PSIP table may be a system information protocol and a program of an MPEG-2 TS based digital broadcast system. The example of generating the PSIP table in the ATSC 3.0 signaling analyzer 130-2 will be described further with reference to FIG. 5.

The ATSC 3.0 signaling analyzer 130-2 may provide broadcast program information to a system information (SI) system of an existing digital broadcast headend such that the SI system may generate an SI table related to a broadcast program converted to MPEG-2 TS.

For example, the ATSC 3.0 signaling analyzer 130-2 may extract the ATSC 3.0 signaling information and the ESG information such that the SI system of the digital broadcast headend may generate the SI table related to the broadcast program converted to MPEG-2 TS by analyzing the SLT and the SLS packet, and transmit the ATSC 3.0 signaling information and the ESG information to the SI system of the existing digital broadcast headend. In this example, the ATSC 3.0 signaling analyzer 130-2 may extract the ESG information by discerning a path to transmit an ESG through parsing the SLT included in the LLS packet.

The ATSC 3.0 signaling analyzer 130-2 may transmit the service ID, the major channel number, the minor channel number, and the service name included in the SLT such that the SI system of the existing digital broadcast headend may generate a virtual channel table (VCT).

The ATSC 3.0 signaling analyzer 130-2 may transmit, to the SI system of the existing digital broadcast headend, a major channel number and a minor channel number included in a service fragment of an ATSC 3.0 based ESG, a content ID, a start time, an end time, and a duration included in a schedule fragment of the ATSC 3.0 based ESG, and a name, a description, and a content advisory value included in a content fragment of the ATSC 3.0 based ESG such that the SI system of the existing digital broadcast headend may generate an event information table (EIT) and an event text table (ETT).

The ATSC 3.0 signaling analyzer 130-2 may output the generated PSIP table to the MPEG-2 TS re-multiplexer 130-4. The ATSC 3.0 signaling analyzer 130-2 may output information for SI table generation, that is, the broadcast program information, to the SI system of the digital broadcast headend.

The codec converter 130-3 may convert compression schemes of the A/V packets to compression scheme of MPEG-2 TS based A/V packets. For example, the codec converter 130-3 may convert the compression scheme of the video packet to at least one of MPEG-2, advanced video coding (AVC), and high efficiency video codec (HEVC) which are compression schemes of the MPEG-2 TS based video packet. The codec converter 130-3 may convert the compression scheme of the audio packet to at least one of MPEG-2 and audio codec 3 (AC3) which are compression schemes of the MPEG-2 TS based audio packet.

In a case in which the compression schemes of the first network based A/V packets are different from the compression scheme of the second network based A/V packets, the codec converter 130-3 may convert the compression schemes of the A/V packets to compression schemes of the second network based A/V packets to be retransmitted.

In a case in which the compression schemes of the first network based A/V packets are the same as the compression scheme of the second network based A/V packets, the codec converter 130-3 may not convert the compression schemes of the A/V packets.

The codec converter 130-3 may output the MPEG-2 TS based A/V packets to the MPEG-2 TS re-multiplexer 130-4.

The MPEG-2 TS re-multiplexer 130-4 may multiplex the MPEG-2 TS based A/V packets and the PSIP table to an MPEG-2 TS packet. For example, the MPEG-2 TS re-multiplexer 130-4 may generate the MPEG-2 TS packet by multiplexing the MPEG-2 TS based A/V packets and the PSIP table. The MPEG-2 TS packet may be a packet according to a standard of international organization for standardization/international electrotechnical commission (ISO/IEC) 13818-1 (MPEG-2 system).

The MPEG-2 TS re-multiplexer 130-4 may output the MPEG-2 TS packet to the transmitter 150.

The transmitter 150 may convert and/or modulate the MPEG-2 TS packet to the second network based digital broadcast signal and the second network based IP packet. The second network based digital broadcast signal and the second network based IP packet may be an MPEG-2 TS based digital broadcast signal and an MPEG-2 TS based IP packet. In this example, the MPEG-2 TS based digital broadcast signal may be an MPEG-2 TS based RF signal, and the MPEG-2 TS based IP packet may be an MPEG-2 TS over IP packet for IP based real-time streaming.

The transmitter 150 may transmit broadcast data to which the MPEG-2 TS packet is converted and/or modulated, and the broadcast program information through the second network 300. For example, the broadcast data may be at least one of a second network based digital broadcast signal and a second network based IP packet, that is, at least one of the MPEG-2 TS based digital broadcast signal and the MPEG-2 TS based IP packet.

The transmitter 150 may include a modulator 150-1, and an IP output interface 150-3.

The modulator 150-1 may modulate the MPEG-2 TS packet converted and multiplexed by the MPEG-2 TS re-multiplexer 130-4 to the second network based digital broadcast signal, and transmit the second network based digital broadcast signal to the second network 300.

In an example, the modulator 150-1 modulate the MPEG-2 TS packet to a digital broadcast signal which is based on an MPEG-2 TS based RF signal transmission scheme, and transmit the modulated signal to an MPEG-2 TS system using an MPEG-2 TS based system frequency.

In another example, in a case of a domestic cable broadcast system, the modulator 150-1 may modulate the MPEG-2 TS packet to a domestic cable broadcast signal which is based on a quadrature amplitude modulation (QAM) scheme, and transmit the modulated signal to the domestic cable broadcast system using a frequency of the domestic cable broadcast system.

The IP output interface 150-3 may convert the MPEG-2 TS packet to the second network based IP packet.

The IP output interface 150-3 may transmit the converted second network based IP packet and the broadcast program information to the second network 300. For example, the IP output interface 150-3 may transmit the broadcast program information to the SI system of the digital broadcast headend through the second network 300.

The IP output interface 150-3 may convert the MPEG-2 TS packet to the MPEG-2 TS based IP packet by incorporating the MPEG-2 TS packet in a payload of the IP packet and transmit the MPEG-2 TS based IP packet. The MPEG-2 TS based IP packet may be TS over IP data.

FIG. 4 is a flowchart illustrating an example of extracting A/V packets through an ATSC 3.0 A/V demultiplexer of FIG. 3.

Referring to FIG. 4, in operation S410, the ATSC 3.0 A/V demultiplexer 130-1 may receive an LLS packet. The LLS packet may include a destination address of 224.0.23.60 and a port number of 4937 defined by the ATSC 3.0 standard.

In operation S420, the ATSC 3.0 A/V demultiplexer 130-1 may analyze an SLT included in the LLS packet. In operation S430, the ATSC 3.0 A/V demultiplexer 130-1 may verify an ATSC 3.0 based transmission protocol based on the SLT analysis.

When the protocol corresponds to ROUTE, the ATSC 3.0 A/V demultiplexer 130-1 may verify a USBD, an S-TSID, and an MPD included in the IP packet by receiving and analyzing an SLS packet, and receive and analyze the USBD, the S-TSID, and the MPD, in operation S440.

In operation S450, the ATSC 3.0 A/V demultiplexer 130-1 may extract A/V packets included in the IP packet by analyzing the USBD, the S-TSID, and the MPD.

When the protocol does not correspond to ROUTE, for example, when the protocol corresponds to MMTP, the ATSC 3.0 A/V demultiplexer 130-1 may verify the USBD and an MMT Package Table (MP table) included in the IP packet by receiving and analyzing the SLS packet, and receive and analyze the USBD and the MP Table, in operation S460.

In operation S470, the ATSC 3.0 A/V demultiplexer 130-1 may extract the A/V packets included in the IP packet based on the analysis of the USBD and the MP Table.

FIG. 5 is a flowchart illustrating an example of generating a PSIP table through the ATSC 3.0 signaling analyzer 130-2 of FIG. 3.

Referring to FIG. 5, in operation S505, the ATSC 3.0 signaling analyzer 130-2 may receive an LLS packet.

In operation S510, the ATSC 3.0 signaling analyzer 130-2 may verify an SLT. In operation S515, the ATSC 3.0 signaling analyzer 130-2 may generate a VCT providing information related to a virtual channel in PSIP using a service ID, a major channel number, a minor channel umber, and a service name included in the SLT.

In operation S520, the ATSC 3.0 signaling analyzer 130-2 may verify an RRT. In operation S525, the ATSC 3.0 signaling analyzer 130-2 may generate an RRT table providing region and rating information in PSIP.

In operation S530, the ATSC 3.0 signaling analyzer 130-2 may verify a system time. In operation S535, the ATSC 3.0 signaling analyzer 130-2 may generate an STT providing time information in PSIP by converting a time value obtained from the system time to a global positioning system (GPS) time.

In operation S540, the ATSC 3.0 signaling analyzer 130-2 may generate a PSIP table including the VCT, the RRT, and the STT, and generate a master guide table (MGT) to provide various table ID values of PSIP.

In operation S545, the ATSC 3.0 signaling analyzer 130-2 may store the PSIP table. In operation S550, the ATSC 3.0 signaling analyzer 130-2 may output the PSIP table at predetermined intervals for each table.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A retransmission apparatus, comprising:
a receiver configured to selectively receive at least one of an advanced television systems committee (ATSC) 3.0 based digital broadcast signal and an ATSC 3.0 based Internet Protocol (IP) packet input through a first network;
a controller configured to generate a moving picture experts group-2 transport stream (MPEG-2 TS) packet by converting audio/video (A/V) packets and signaling information to be received at a second network based on an output signal of the receiver, and extract and provide broadcast program information for a system information (SI) system of a digital broadcast headend to generate an SI table related to a broadcast program converted to MPEG-2 TS; and
a transmitter configured to transmit broadcast data to which the MPEG-2 TS packet is converted and the broadcast program information through the second network.

2. The retransmission apparatus of claim 1, wherein the ATSC 3.0 based digital broadcast signal is an ATSC 3.0 based radio frequency (RF) signal, and
the broadcast data is at least one of a second network based digital broadcast signal to which the MPEG-2 TS packet is modulated and a second network based IP packet to which the MPEG-2 TS packet is converted.

3. The retransmission apparatus of claim 2, wherein the receiver comprises:
an IP input interface configured to receive the ATSC 3.0 based IP packet; and
a demodulator configured to demodulate the ATSC 3.0 based RF signal, and extract the ATSC 3.0 based IP packet.

4. The retransmission apparatus of claim 3, wherein the controller comprises:
an ATSC 3.0 A/V demultiplexer configured to extract the A/V packets by analyzing the ATSC 3.0 based IP packet;
a signaling analyzer configured to analyze the ATSC 3.0 based signaling information, generate an MPEG-2 TS based program and system information protocol (PSIP) table from the ATSC 3.0 based signaling information, and extract and provide the broadcast program information;
a codec converter configured to convert compression schemes of the A/V packets to compression schemes of MPEG-2 based A/V packets; and
an MPEG-2 TS re-multiplexer configured to convert and multiplex the MPEG-2 based A/V packets and the MPEG-2 TS based PSIP table to the MPEG-2 TS packet.

5. The retransmission apparatus of claim 4, wherein the transmitter comprises:
a modulator configured to convert the MPEG-2 TS packet to an MPEG-2 TS based RF signal; and
an IP output interface configured to convert the MPEG-2 TS packet to an MPEG-2 TS based IP packet, transmit the MPEG-2 TS based IP packet, and transmit the broadcast program information to the SI system.

6. The retransmission apparatus of claim 4, wherein the ATSC 3.0 A/V demultiplexer is configured to extract the A/V packets by analyzing a low level signaling (LLS), a service list table (SLT), and a service level signaling (SLS) from the ATSC 3.0 based IP packet.

7. The retransmission apparatus of claim 6, wherein the ATSC 3.0 A/V demultiplexer is configured to:
extract the A/V packets by analyzing a user service bundle description (USBD), a service-based transport session instance description (S-TSID), and a media processing descriptor (MPD) when the A/V packets are transmitted using real-time object delivery over unidirectional transport (ROUTE), and
extract the A/V packets by analyzing the USBD and an MPEG multimedia transport (MMT) package table (MP table) when the A/V packets are transmitted using MPEG media transport protocol (MMTP),
wherein the ATSC 3.0 based IP packet includes the USBD, the S-TSID, the MPD, and the MP table.

8. The retransmission apparatus of claim 6, wherein the SLT includes information related to a service identification (ID), a service name, a protocol type, a product liability prevention (PLP) number, an IP address, a port number, a major channel number, a minor channel number, and a short service name.

9. The retransmission apparatus of claim 4, wherein the PSIP table includes a master guide table (MGT), a virtual channel table (VCT), a rating region table (RRT), a system time table (STT), an event information table (EIT), and an event text table (ETT).

10. The retransmission apparatus of claim 4, wherein the codec converter is configured to:
convert the compression scheme of the video packet to at least one of MPEG-2, advanced video coding (AVC), and high efficiency video codec (HEVC) which are compression schemes of the MPEG-2 TS based video packet, and
convert the compression scheme of the audio packet to at least one of MPEG-2 and audio codec 3 (AC3) which are compression schemes of the MPEG-2 TS based audio packet.

11. A retransmission method, comprising:
selectively receiving at least one of an advanced television systems committee (ATSC) 3.0 based digital broadcast signal and an ATSC 3.0 based Internet Protocol (IP) packet input through a first network;
generating a moving picture experts group-2 transport stream (MPEG-2 TS) packet by converting audio/video (A/V) packets and signaling information to be received at a second network based on at least one of the ATSC 3.0 based digital broadcast signal and the ATSC 3.0 based IP packet, and extracting and providing broadcast program information for a system information (SI) system of a digital broadcast headend to generate an SI table related to a broadcast program converted to MPEG-2 TS; and
transmitting broadcast data to which the MPEG-2 TS packet is converted and the broadcast program information through the second network.

12. The retransmission method of claim 11, wherein the ATSC 3.0 based digital broadcast signal is an ATSC 3.0 based radio frequency (RF) signal, and
the broadcast data is at least one of a second network based digital broadcast signal to which the MPEG-2 TS packet is modulated and a second network based IP packet to which the MPEG-2 TS packet is converted.

13. The retransmission method of claim 12, wherein the receiving comprises:
receiving the ATSC 3.0 based IP packet; and
demodulating the ATSC 3.0 based RF signal, and extracting the ATSC 3.0 based IP packet.

14. The retransmission method of claim 13, wherein the generating comprises:
extracting the A/V packets by analyzing the ATSC 3.0 based IP packet;
analyzing the ATSC 3.0 based signaling information, generating an MPEG-2 TS based program and system information protocol (PSIP) table from the ATSC 3.0 based signaling information, and extracting and providing the broadcast program information;
converting compression schemes of the A/V packets to compression schemes of MPEG-2 based A/V packets; and
converting and multiplexing the MPEG-2 based A/V packets and the MPEG-2 TS based PSIP table to the MPEG-2 TS packet.

15. The retransmission method of claim 14, wherein the transmitting comprises:
converting the MPEG-2 TS packet to an MPEG-2 TS based RF signal; and
converting the MPEG-2 TS packet to an MPEG-2 TS based IP packet, transmitting the MPEG-2 TS based IP packet, and transmitting the broadcast program information to the SI system.

16. The retransmission method of claim 14, wherein the extracting of the A/V packets comprises extracting the A/V packets by analyzing a low level signaling (LLS), a service list table (SLT), and a service level signaling (SLS) from the ATSC 3.0 based IP packet.

17. The retransmission method of claim 16, wherein the extracting of the A/V packets comprises:
extracting the A/V packets by analyzing a user service bundle description (USBD), a service-based transport session instance description (S-TSID), and a media processing descriptor (MPD) when the A/V packets are transmitted using real-time object delivery over unidirectional transport (ROUTE), and
extracting the A/V packets by analyzing the USBD and an MPEG multimedia transport (MMT) package table (MP table) when the A/V packets are transmitted using MPEG media transport protocol (MMTP),
wherein the ATSC 3.0 based IP packet includes the USBD, the S-TSID, the MPD, and the MP table.

18. The retransmission method of claim 16, wherein the SLT includes information related to a service identification (ID), a service name, a protocol type, a product liability prevention (PLP) number, an IP address, a port number, a major channel number, a minor channel number, and a short service name.

19. The retransmission method of claim 14, wherein the PSIP table includes a master guide table (MGT), a virtual channel table (VCT), a rating region table (RRT), a system time table (STT), an event information table (EIT), and an event text table (ETT).

20. The retransmission method of claim 14, wherein the converting of the compression schemes of the A/V packets comprises:
converting the compression scheme of the video packet to at least one of MPEG-2, advanced video coding (AVC), and high efficiency video codec (HEVC) which are compression schemes of the MPEG-2 TS based video packet, and
converting the compression scheme of the audio packet to at least one of MPEG-2 and audio codec 3 (AC3) which are compression schemes of the MPEG-2 TS based audio packet.
